(19) United States
(12) Patent Application Publication
(10) Pub. No.: US 2010/0316498 A1
(43) Pub. Date: Dec. 16, 2010

(54) FAN MANUFACTURING AND ASSEMBLY

(75) Inventors: Kevin M. Cahill, Fishers, IN (US); Hooshang Didandeh, Zionsville, IN (US); Eugene Elvin Williams, Frankfort, IN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: HORTON, INC., Roseville, MN (US)

(21) Appl. No.: 12/867,857

(22) PCT Filed: Feb. 19, 2009
(86) PCT No.: PCT/US2009/001028

§ 371 Date: Aug. 16, 2010

Related U.S. Application Data
(60) Provisional application No. 61/066,692, filed on Feb. 22, 2008.

(51) Int. Cl. F01D 5/22; B29C 65/14; B29C 45/14

(52) U.S. Cl. 416/189; 156/272.4; 156/245

(57) ABSTRACT

A method of making a fan (20) includes making a subassembly (48) comprising a backplate (22) and a plurality of blades (24) extending from the backplate (22), making a fan shroud (26), positioning the fan shroud (26) adjacent to the blades (24) of the subassembly (48), providing ferromagnetic particles at a first weld location, and directing electromagnetic energy toward the ferromagnetic particles at the first weld location to melt surrounding material and structurally join the fan shroud (26) and at least one of the blades (24).

### BACKGROUND

The present invention relates to fans and fan assemblies suitable for automotive applications, as well as methods for manufacturing and assembling the same.

Fans for cooling systems, such as those for under-hood automotive cooling applications, should be durable and sturdy to withstand anticipated operating conditions. Moreover, the construction of the fans and the techniques used to manufacture and/or assemble the fan must be efficient, reliable and cost-effective.

Injection molding techniques using polymers are frequently employed to fabricate automotive fans. However, not all injection molding techniques are equally effective for particular fan configurations. Some techniques may introduce undesirable complications to the fabrication process. Some techniques may also be more costly than others, which is undesirable as well.

In addition, it is desirable to reduce the amounts of time and labor required to complete fabrication of each fan, and to allow the fabrication process to be scaled to desired production levels, including mass production. Extensive assembly operations to attach many different subcomponents together tends to increase the time and labor required for fabrication. It is further desirable to reduce scrap and rework.

Thus, an alternative fan and an associated manufacturing and assembly technique is desired.

### SUMMARY

A method of making a fan includes making a subassembly comprising a backplate and a plurality of blades extending from the backplate, making a fan shroud, positioning the fan shroud adjacent to the blades of the subassembly, providing ferromagnetic particles at a first weld location, and directing electromagnetic energy toward the ferromagnetic particles at the first weld location to melt surrounding material and structurally join the fan shroud and at least one of the blades.

### BRIEF DESCRIPTION OF THE DRAWINGS

FIG. 1 is a perspective view of a fan according to the present invention.

FIG. 2 is an exploded perspective view of the fan.

FIG. 3 is a perspective view of a portion of the fan.

FIG. 4 is a perspective view of a portion of a shroud of the fan.

FIGS. 5-7 are perspective views of a cap of the fan.

FIG. 8 is a partially exploded perspective view of a portion of the fan.

FIG. 9A is a cross-sectional view of a portion of the fan, taken along line 9-9 of FIG. 1, shown prior to a welding operation.

FIG. 9B is a cross-sectional view of the portion of the fan, taken along line 9-9 of FIG. 1, shown subsequent to a welding operation.

FIG. 10 is a top view of a manufacturing system for welding the fan.

FIG. 11 is a flow chart of a manufacturing method according to the present invention.

FIG. 12 is a flow chart of an alternative manufacturing method according to the present invention.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

The present invention claims priority to U.S. Provisional Patent Application No. 61/066,692 entitled “High Efficiency Hybrid Flow Fan,” filed Feb. 22, 2008, which is hereby incorporated by reference in its entirety.

The present invention provides a fan assembly and a method of making a fan. In general, the fan assembly includes a fan shroud, a subassembly, and a plurality of caps, and in operation generates a hybrid axial and radial airflow (i.e., airflow in a direction in between the radial and axial directions). The subassembly includes an at least partially frusto-conical backplate integrally formed with a plurality of blades. The fan shroud is separately formed and attached to the blades and caps. In one embodiment, the blades pass at least partially into slots in the fan shroud, with a cap positioned adjacent to each blade at a side of the fan shroud opposite the backplate. In one embodiment, components of the fan are made of a polymer material, and the fan shroud is attached to the blades using a high-frequency electromagnetic welding process. Strands of joining (or welding) material that contain ferromagnetic particles activated by the high-frequency electromagnetic energy can be used to melt surrounding materials and form a weld joint, or alternatively the ferromagnetic particles can be integrated into at least a portion of the caps, the shroud and/or the subassembly at the desired location of the weld joint. Such a method allows the fan assembly to be fitted together and optionally inspected prior to welding, thereby helping to reduce scrap and post-welding re-work. The welding process also essentially avoids the creation of sprue during assembly, which helps reduce scrap and finishing requirements. Additional details and features of the present invention will be recognized in view of the description that follows. For instance, nearly any thermoplastic, thermoset or resin materials can be used to make fan components, as desired for particular applications. Moreover, the ferromagnetic particles of the joining material can be provided as a ferromagnetic polymer matrix.

FIG. 1 is a perspective view of a fan 20 that includes a backplate 22, a plurality of blades (or airfoils) 24, a fan shroud 26, and a plurality of caps 28. In the illustrated embodiment, the fan 20 is configured to rotate in a clockwise direction, though other configurations are possible. It should be noted that the illustrated embodiment of the fan 20 is provided by way of example and not limitation. Those of ordinary skill in the art will appreciate the present invention is applicable to a variety of fan configurations in alternative embodiments.

The backplate 22, which is generally arranged perpendicular to an axis of rotation of the fan 20, includes a substantially planar inner diameter (ID) portion (also called a hub) 34 and a frusto-conical outer diameter (OD) portion 36. A metallic disk 38 (e.g., made of steel, aluminum, etc.) is optionally incorporated into the ID portion 34 to provide a relatively rigid structure for attachment of the fan apparatus 20 to a clutch or other rotational input source (not shown), such as a viscous clutch of the type disclosed in PCT Published Application No. WO 2007/016497 A1. In the illustrated embodiment, the OD portion 36 extends to a perimeter (i.e., circumference) of the fan 20. The OD portion 36 of the backplate 22 is arranged at an angle (e.g., approximately 65-80°) with respect to the axis of rotation of the fan 20. Generally, a discharge angle of airflow exiting the fan 20 is approximately equal to the angle of the OD portion 36 of the backplate 22.

The fan shroud 26 is secured relative to each of the blades 24 opposite the backplate 22, and rotates with the rest of the fan 20 during operation. In the illustrated embodiment, the fan shroud 26 has a generally annularly shaped body, and is at least partially curved in a toroidal, converging-diverging configuration. An ID portion of the fan shroud 26 curves away from the backplate 22. In one embodiment, an inlet shroud (not shown) is positioned adjacent to the fan 20 to extend within an upstream portion of the fan shroud 26, in order to help guide airflow into the fan 20.

The blades 24 extend from generally the OD portion 36 of the backplate 22 to the fan shroud 26. In the illustrated embodiment, a total of sixteen blades 24 are provided, though the number of blades 24 can vary in alternative embodiments (e.g., a total of eighteen, etc.). Each blade 24 defines a leading edge 44 and a trailing edge 46, and those skilled in the art will appreciate that opposite pressure and suction sides of the blades 24 extend between the leading and trailing edges 44 and 46. In the illustrated embodiment the leading edges 44 of the blades 24 are not attached to the fan shroud 26.

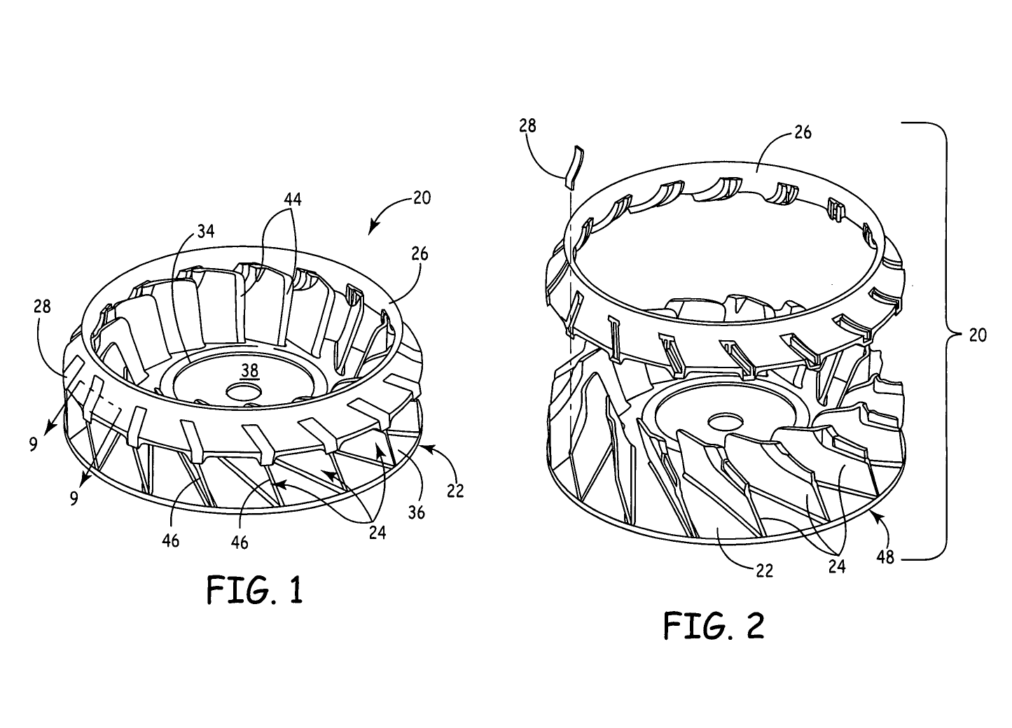

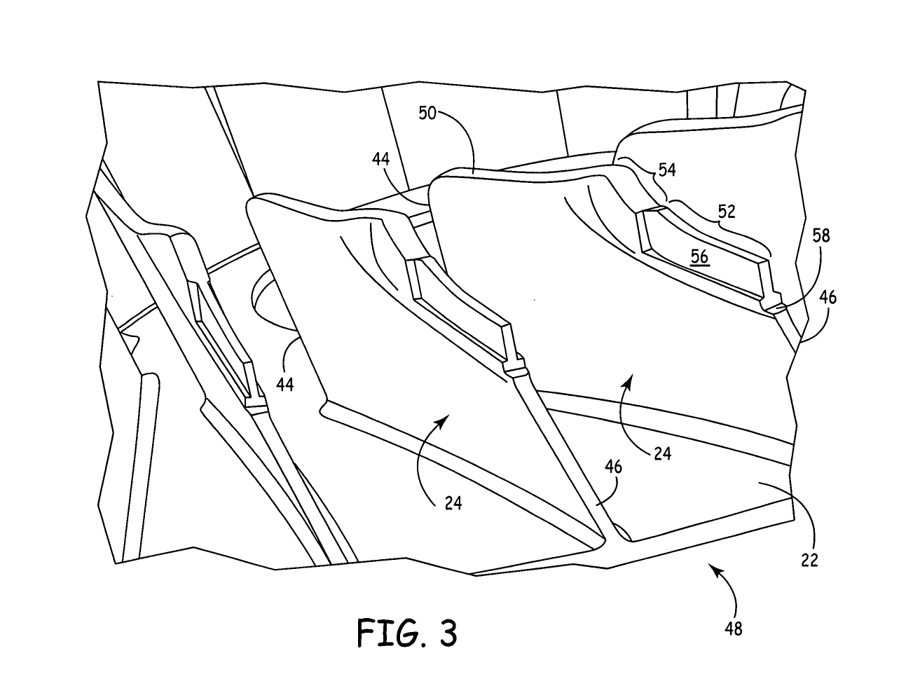

FIG. 2 is an exploded perspective view of the fan 20. An integrally formed subassembly 48 is defined by the backplate 22 and the blades 24. As shown in FIG. 2, the subassembly 48, the fan shroud 26, and one of the caps 28 (only one cap 28 is shown for simplicity) are exploded from each other. In alternative embodiments the backplate 22 and at least some of the blades 24 can be separately formed and attached together to form the subassembly 48.

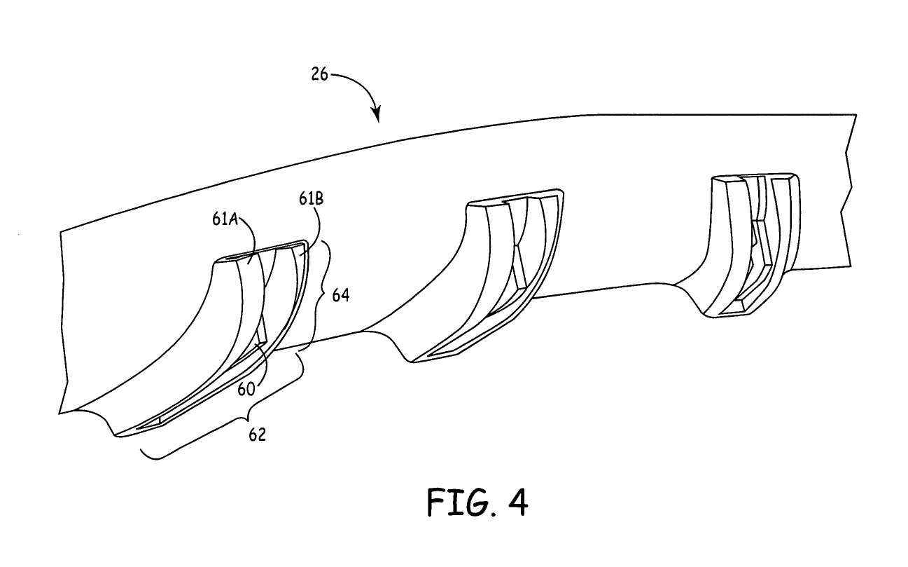

FIG. 3 is a perspective view of a portion of the subassembly 48. As shown in FIG. 3, each of the blades 24 includes a free end 50 located adjacent to the leading edge 44 and an attachment region located adjacent to the trailing edge 46. The attachment region of each blade 24 is located generally opposite the backplate 22 in a spanwise direction, and is defined by a weld area 52 located adjacent to the trailing edge 46 and a captive area 54 located between the weld area 52 and the free end 50. In the illustrated embodiment, the attachment region is tilted relative to the rest of the blade 24. The weld area 52 includes a tab 56 and a notch 58. In the illustrated embodiment, the tab 56 has a substantially rectangular cross-sectional shape, and is thinner than adjacent portions of the blade 24, including being thinner than the captive area 54. The notch 58 is located generally downstream of the tab 56, at or near the trailing edge 46. Both the weld area 52 and the captive area 54 of the attachment region can be curved in a manner corresponding to curvature of the fan shroud 26. It should be noted that the captive area 54 is optional. For instance, in alternative embodiments, either the free end 50 or the weld area 52 can be extended to replace all or part of the captive area 54.

FIG. 4 is a perspective view of a portion of the fan shroud 26, which defines a plurality of openings 60. Each of the openings 60 corresponds to one of the blades 24, and is configured to accept at least a portion of the attachment region of the corresponding blade 24. In the illustrated embodiment, each of the openings 60 is generally slot-shaped to accept at least a portion of the tab 56 of a corresponding one of the blades 24. The openings can be radially spaced from a perimeter of the fan shroud 26 (see FIG. 8). A pair of supports 61A and 61B are arranged along opposite sides of each opening 60. Each of the supports 61A and 61B has a first region 62 and a second region 64 located adjacent and upstream relative to the first region 62. Additional details of the fan shroud 26 are described below.

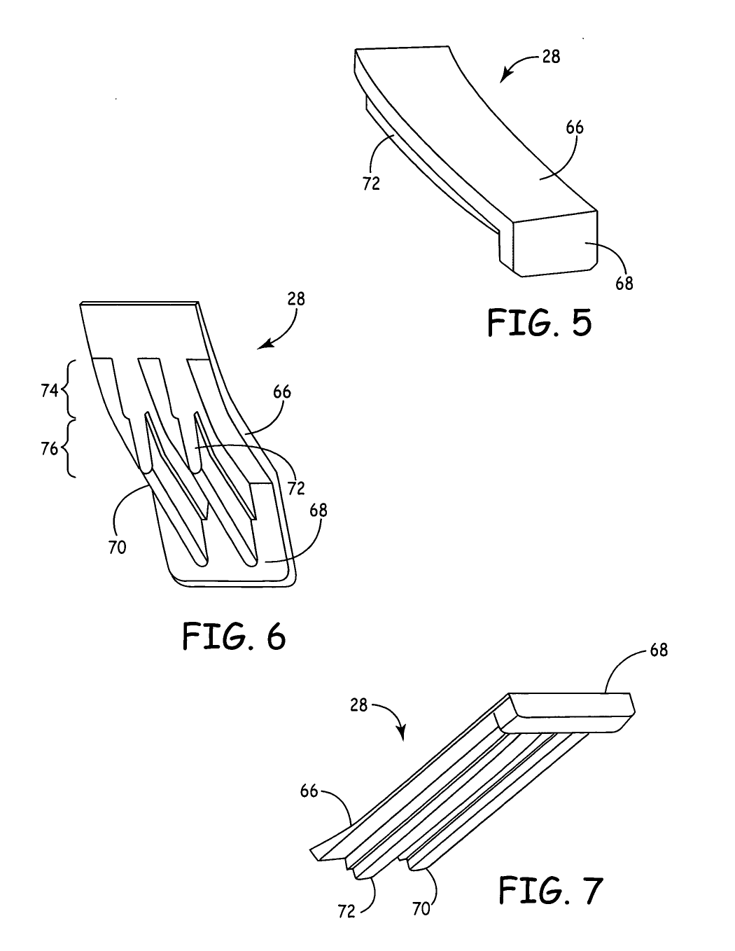

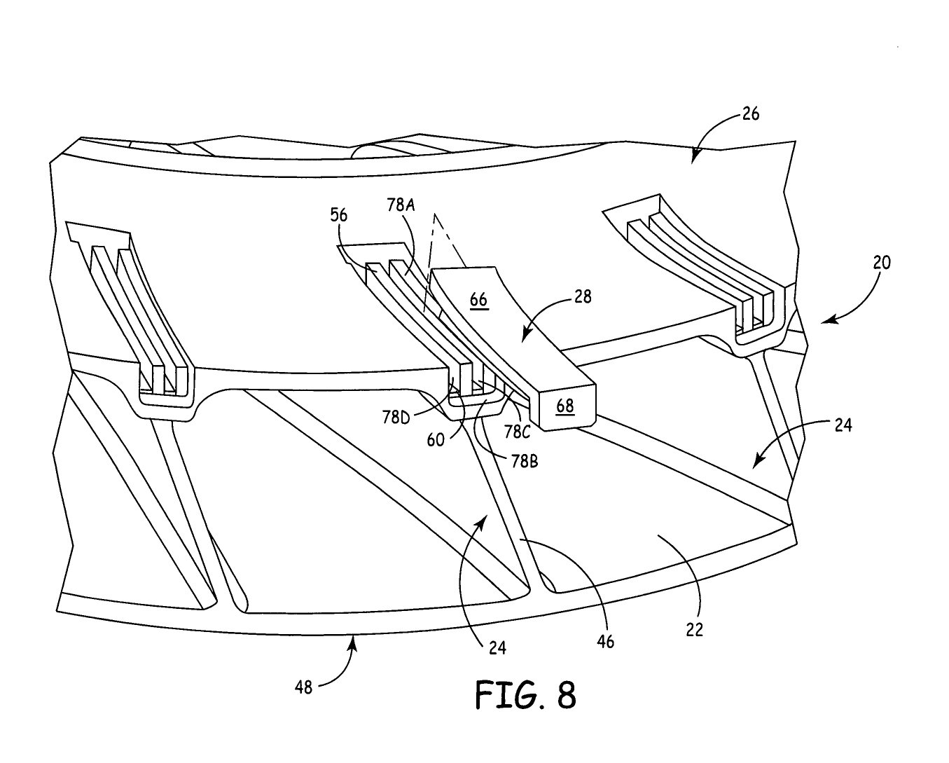

FIGS. 5-7 are various perspective views of one of the caps 28. In the illustrated embodiment, the cap 28 includes a wall 66, a lug 68, and a pair of ribs 70 and 72. The lug 68 and the pair of ribs 70 and 72 all extend from the wall 66. The wall 66 has an elongate configuration, with a curvature that generally corresponds to that of the fan shroud 26. The lug 68 is located at one end of the wall 66, adjoining both of the ribs 70 and 72, and extends generally perpendicular (i.e., transverse) to the ribs 70 and 72. The ribs 70 and 72 extend along substantially an entire length of the wall 66. Each of the ribs 70 and 72 includes a first portion 74 and a second portion 76 (as labeled with respect to the rib 70 in FIG. 6), with the first portion 74 adjoining the wall 66. The first portion 74 is thicker than the second portion 76. Furthermore, a distal end of each rib 70 and 72 can be rounded.

FIG. 8 is a partially exploded perspective view of a portion of the fan 20, shown with the subassembly 48 and the fan shroud 26 assembled together, and one of the caps 28 shown exploded therefrom. The tabs 56 of the blades 24 each extend into a corresponding one of the openings 60 in the fan shroud 26. A recess including a first portion 78A, a second portion 78B, a third portion 78C and a fourth portion 78D is defined about each opening 60. The first portion 78A is configured to accept the wall 66 of the cap 28, such that an exterior surface of the wall 66 is substantially flush with an exterior (i.e., radially outward) surface of the fan shroud 26 when fully assembled. The second portion 78B is configured to accept the lug 68 of the cap 28, such that the lug 68 is substantially flush with the perimeter of the fan shroud 26 when fully assembled. The third and fourth portions 78C and 78D extend along opposite sides of the opening 60 and are configured to accept the ribs 70 and 72, respectively, of the cap 28 when fully assembled. When fully assembled, the tabs 56 of the blades 24 are positioned at least partially amidst the portions 78A-78D of the recess.

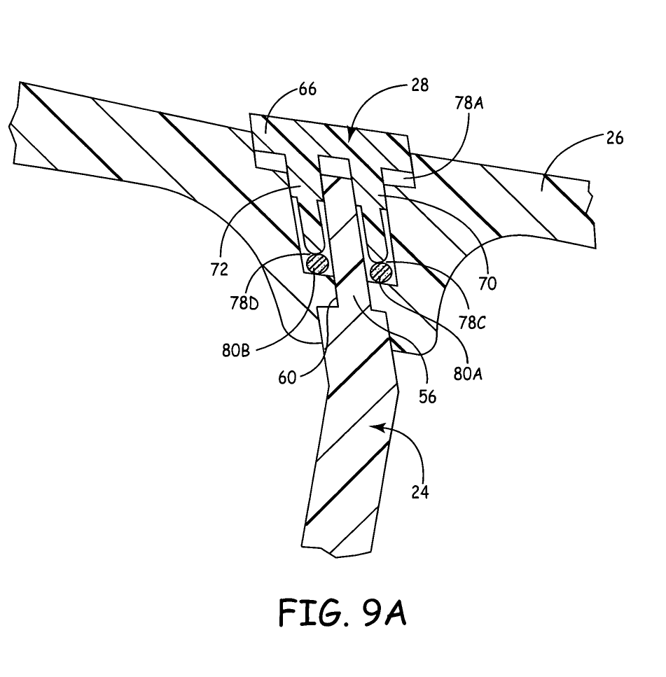

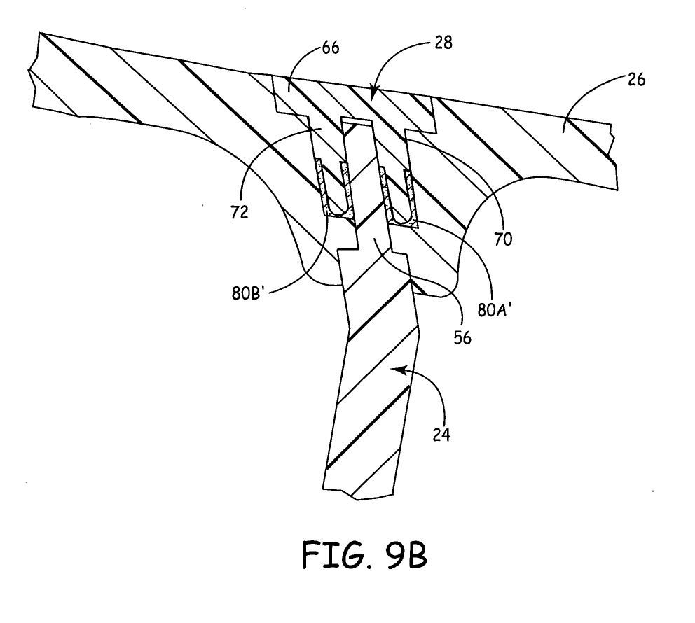

FIG. 9A is a cross-sectional view of a portion of the fan 20, taken along line 9-9 of FIG. 1, shown prior to a welding operation. In the illustrated embodiment, the fan shroud 26 is positioned adjacent to the blades 24, such that the fan shroud 26 is supported by portions of the blade 24 adjacent to the tab 56. First and second strands of joining (or welding) material 80A and 80B are positioned at desired weld locations at opposite sides of the tab 56 of each blade 24 in the third and fourth portions 78C and 78D, respectively, of the recess in fan shroud 26. In one embodiment, each strand 80A and 80B has a diameter of approximately 3.175 mm (0.125 inch) and a length approximately equal to a desired weld joint length. The caps 28 are positioned such that the ribs 70 and 72 are positioned at opposite sides of the tab 56 of each blade 24 and extending into the third and fourth portions 78C and 78D of the recess of the fan shroud 26. Distal ends of the ribs 70 and 72 generally abut the strands 80A and 80B, respectively, which causes the caps 28 to protrude during pre-welding assembly by a distance approximately equal to the diameter of the strands 80A and 80B. The wall 66 can at least partially extend into the first portion 78A of the recess of the fan shroud 26.

The strands 80A and 80B each comprise a polymer material with ferromagnetic particles (e.g., an electromagnetic responsive material) therein. In one embodiment, the polymer material is similar to a material from which the blades 24, the fan shroud 26 and/or the caps 28 are made (e.g., nylon), though dissimilar material can be used in alternative embodiments. As used herein, the term “strands” encompasses strips, threads, tubes, and nearly any other elongate shape. As used herein, the term “particles” encompasses powders, shavings, filings, granules, etc. Furthermore, as used herein, the term “welding” encompasses fusing, bonding, forging, setting and joining.

As will be explained further below, the use of the strands 80A and 80B is optional, and in alternative embodiments the components can be joined in other ways. For instance, weld-activated ferromagnetic particles can be integrally incorporated into structural components, such as the caps 28 or the blades 24.

FIG. 9B is a cross-sectional view of the portion of the fan, taken along line 9-9 of FIG. 1, shown fully assembled subsequent to a welding operation. The welding operation activates the ferromagnetic particles in the strands of weld material 80A and 80B to melt the strands 80A and 80B and portions of nearby structures to form structural weld joints 80A′ and 80B′ that contain the ferromagnetic particles. During welding, the strands 80A and 80B become molten and can flow, for instance, at least partially filling voids in the third and fourth portions 78C and 78D of the recess in the fan shroud 26 adjacent to the thinner second portions 76 of the ribs 70 and 72 of the caps 28. The lugs 68 of the caps 28 can help contain the molten strands of weld material 80A and 80B in the recess portion 78B (see FIG. 8). When the fan 20 is fully assembled, each cap 28 is structurally joined to the corresponding blade 24 and the fan shroud 26. The exterior surface of the wall 66 is substantially flush with the exterior (i.e., radially outward) surface of the fan shroud 26. A small gap can remain between the tabs 56 of the blades 24 and the walls 66 of the caps 28, in order to accommodate dimensional tolerances and potential misalignments. Additionally, the distal ends of the ribs 70 and 72 of the caps 28 do not contact the fan shroud 26, to accommodate dimensional tolerances and potential misalignments. The resultant joint, which includes the weld joints 80A′ and 80B′ formed at opposite sides of each blade 24, is referred to as a “straddle joint”. Moreover, it should be noted that portions of the weld joints 80A′ and 80B′ formed directly between the caps 28 and the blades 24 capture the fan shroud 26, even if for some reason those joints were not formed directly with the fan shroud 26. Further, the presence of the weld joints 80A′ and 80B′ at opposite sides of the blades 24 helps preserve structural integrity even in the event that a weld joint 80A′ or 80B′ at one side of a blade 24 were to fail.

Additional details regarding suitable welding processes and joining (or welding) materials are found in U.S. Pat. Nos. 6,056,844 and 6,939,477.

When the fan is fully assembled, the captive area 54 of each blade 24 is held between the supports 61A and 61B of the fan shroud (see FIGS. 1-4). The captive areas 54 and the corresponding supports 61A and 61B are interlocked, but are typically not bonded together. This relationship helps provide more strength to the blades 24 and helps keeps the blades 24 from moving during fan operation.

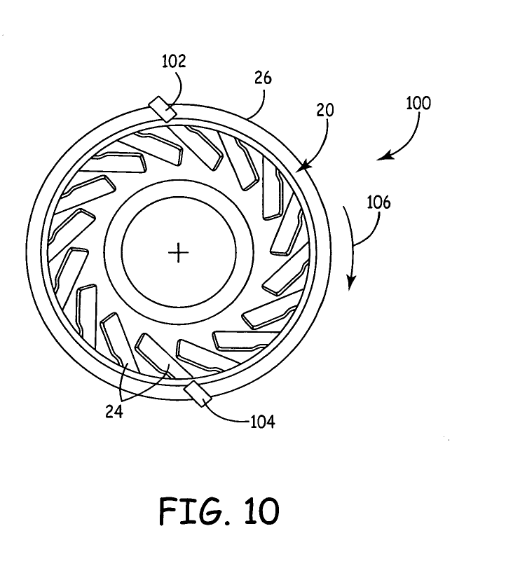

FIG. 10 is a top view of a manufacturing system 100 for welding the fan 20. In general, the assembled but unwelded fan 20 is placed in a suitable fixture (not shown). Then work coils are positioned adjacent to one or more desired weld locations to perform welding. In the illustrated embodiment, two work coils 102 and 104 are utilized to perform welding relative to two weld locations (i.e., relative to two different blades 24) simultaneously, with the work coils 102 and 104 located approximately 180° apart from one another (i.e., at opposite regions of the fan 20). The work coils 102 and 104 are each aligned with the desired bond line (i.e., weld joint 80A′ and 80B′) to be formed. Each work coil 102 and 104 can be a high-frequency, liquid-cooled copper coil of any suitable configuration. It is possible for each coil 102 and 104 to include multiple portions, for instance to extend along both the front and back of the fan shroud 26. When activated, the work coils 102 and 104 each generate a high-frequency (e.g., approximately 13.56 MHz) electromagnetic field that reaches the ferromagnetic particles of the strands of weld material 80A and 80B to perform welding.

Once welds have been performed at the first two weld locations, the fan 20 is rotated and the work coils 102 and 104 positioned at a different pair of weld locations. In the illustrated embodiment, an arrow 106 designates rotation of the fan 20 in a clockwise direction, though it should be recognized that rotation can be in a counterclockwise direction in an alternative embodiment. The process of welding and rotating the fan 20 can be repeated until all desired welds are performed, which generally depends upon the number of blades 24 and the corresponding number of weld joints desired to be formed.

During welding, seating pressure can be applied to each weld location. Small platens (not shown) connected to one or more pneumatic cylinder assemblies (not shown) can be used to apply pressure to the caps 28 at the desired weld locations during welding. Seating pressure facilitates welding, and can help move the caps 28 into their final, fully-assembled positions.

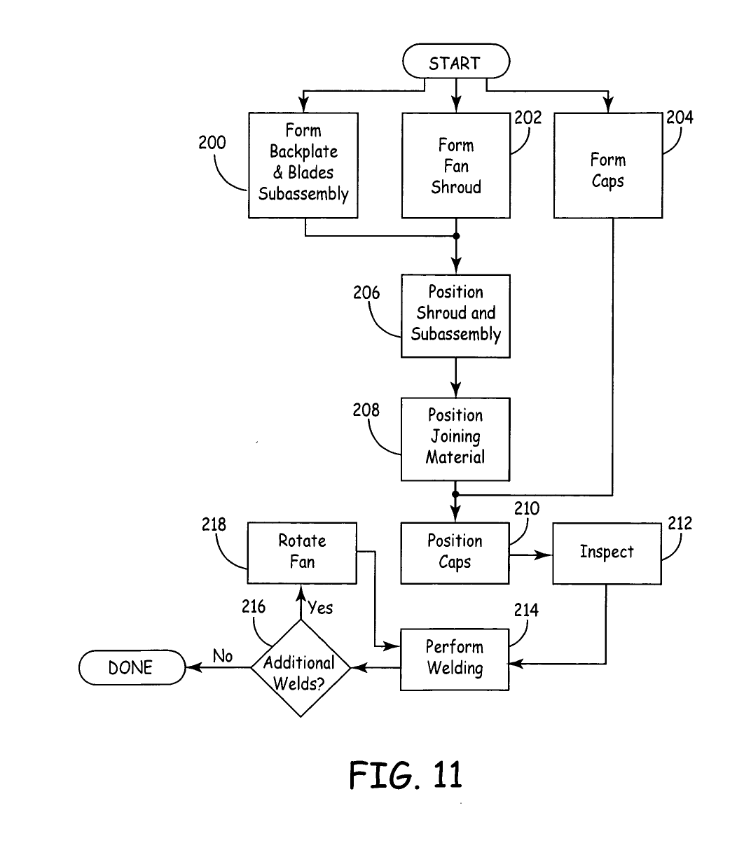

FIG. 11 is a flow chart of one embodiment of a manufacturing method. According to the illustrated embodiment of the method, first the subassembly 48 including the backplate 22 and the blades 24 is formed (step 200), the fan shroud 26 is formed (step 202), and the caps 28 are formed (step 204). Steps 200, 202 and 204 can be performed in any desired order, or simultaneously. Typically, steps 200, 202 and 204 are performed using conventional injection molding processes, though other techniques can be used in alternative embodiments. Next, the fan shroud 26 and the subassembly 48 are positioned together, such that the tabs 56 of the blades 24 at least partially extend into or through the openings 60 in the fan shroud 26 (step 206). The fan shroud 26 and the subassembly 48 can be positioned together in a suitable jig or fixture. Interlocking of the captive areas 54 of each blade 24 with the corresponding supports 61A and 61B can help hold the subassembly 48 and the fan shroud 26 in place relative to each other prior to welding. Attachment regions of each blade 24, as well as the supports 61A and 61B of the fan shroud 26, can be arranged substantially axially to facilitate assembly. Such an arrangement is helpful when other portions of the blades 24 are tilted, that is, non-axially arranged. This allows the fan shroud 26 to be attached to the subassembly 48 with relatively simple and substantially axial movement.

At least one strand of joining material 80A and 80B is then positioned adjacent each blade at each desired weld location (step 208). Typically the welding material is positioned relative to all of the blades 24 at the same time. Once the joining material is in place, the caps 28 are positioned in place adjacent to the fan shroud 26 and the blades 24 (step 210). Again, typically all of the caps 28 are positioned in place at the same time, prior to welding any of them. Next, an optional inspection can be performed to help verify that the fan 20 is assembled correctly (step 212). The inspection allows for readjustment of parts, for instance, if one of the caps 28 is not seated properly.

Once the fan 20 is loosely assembled, a welding operation is performed to form weld joints at one or more desired weld locations (step 214). The welding operation can include applying a seating pressure to the cap(s) 28 being welded and applying a high-frequency electromagnetic field to the joining material 80A and 80B to form fused plastic assembly with structural weld joints 80A′ and 80B′. Interlocking of the captive areas 54 of each blade 24 with the corresponding supports 61A and 61B can help hold the subassembly 48 and the fan shroud 26 in place relative to each other during a welding operation. Typically the welding operation of step 214 is performed only at one or two locations at a time. An assessment is made as to whether additional welds are required (step 216). If additional welds are required, a rotational movement between the fan 20 and the welding equipment is performed (step 218), and then an additional welding operation (step 214) is performed at one or more new weld locations—as many additional welds can be performed as desired. If no more welds are required, the manufacturing and assembly process can finish.

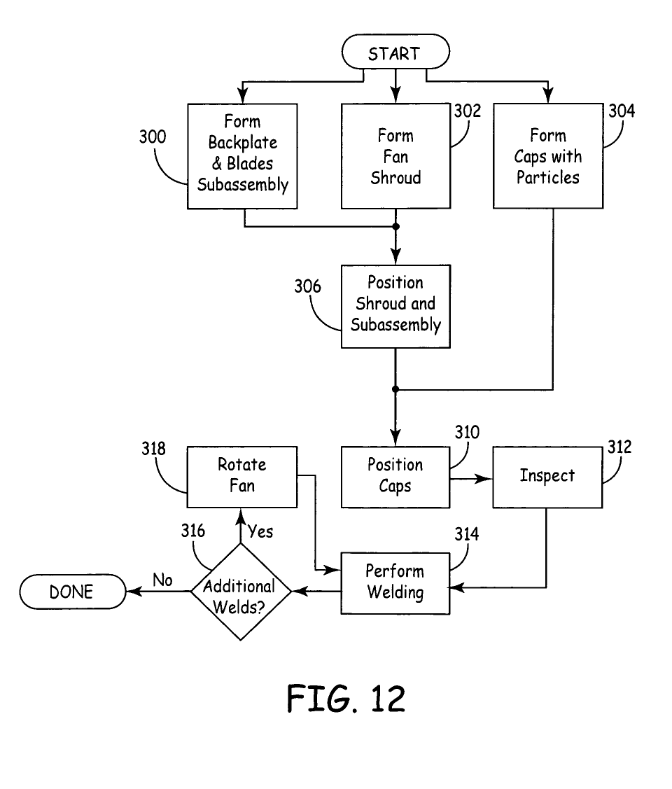

FIG. 12 is a flow chart of an alternative embodiment of the manufacturing method. The alternative embodiment of the method is similar to that described with respect to FIG. 11, except that joining material is integrated into at least one of the caps 28, the blades 24 or the fan shroud 26 instead of (or in addition to) providing separate strands of welding material. According to the embodiment of the method illustrated in FIG. 12, first the subassembly 48 including the backplate 22 and the blades 24 is formed (step 300), the fan shroud 26 is formed (step 302), and the caps 28 are formed with a ferromagnetic particles integrally present in at least a portion thereof (step 304). Steps 300, 302 and 304 can be performed in any desired order, or simultaneously. Typically, steps 300, 302 and 304 are performed using conventional injection molding processes, though other techniques can be used in alternative embodiments. In order to provide the ferromagnetic particles in the caps 28, a separate injection path can be provided in a mold, or a portion of the cap 28 can be overmolded with ferromagnetic particle-containing material. In one embodiment, the ferromagnetic particles are provided at the second portions 76 of the ribs 70 and 72.

Next, the fan shroud 26 and the subassembly 48 are positioned together, such that the tabs 56 of the blades 24 at least partially extend into or through the openings 60 in the fan shroud 26 (step 306). The fan shroud 26 and the subassembly 48 can be positioned together in a suitable jig or fixture. Then caps 28 are positioned in place adjacent to the fan shroud 26 and the blades 24 (step 310). Typically all of the caps 28 are positioned in place at the same time, prior to welding any of them. Next, an optional inspection can be performed to help verify that the fan 20 is assembled correctly (step 312). This inspection step allows for readjustment of parts, for instance, if one of the caps 28 is not seated properly.

Once the fan 20 is loosely assembled, a welding operation is performed to form weld joints at one or more desired weld locations (step 314). The welding operation can include applying a seating pressure to the cap(s) 28 being welded and applying a high-frequency electromagnetic field to the joining material to form fused plastic assembly with structural weld joints 80A′ and 80B′ (which can be substantially similar to those formed using discrete strands of the joining material 80A and 80B). Typically the welding operation of step 314 is performed only at one or two locations at a time. An assessment is made as to whether additional welds are required (step 316). If additional welds are required, a rotational movement between the fan 20 and the welding equipment is performed (step 318), and then an additional welding operation (step 314) is performed at one or more new weld locations—as many additional welds can be performed as desired. If no more welds are required, the manufacturing and assembly process can finish.

It will be recognized that the present invention provides numerous advantages and benefits. For example, the present invention provides a relatively fast, reliable and efficient method of manufacturing and assembling a fan. Moreover, the present invention allows for pre-welding assembly and inspection, which can help reduce scrap and rework. The present invention also provides advantages over other possible manufacturing and assembly techniques. Molding the fan shroud 26 integrally with the blades 24 (either in a one-piece or two-piece assembly) may produce undesirable “die lock” situations where unintended shapes of the fan shroud 26 are produced that decrease performance (e.g., producing undesired turbulent airflows). Alternatively, the backplate 22, the blades 24 and the fan shroud 26 of the fan 20 can all be separately formed and mechanically attached together; but while that method generally reduces tooling complexity and cost, it makes assembly of the formed parts more labor-intensive and time-consuming.

Although the present invention has been described with reference to preferred embodiments, workers skilled in the art will recognize that changes may be made in form and detail without departing from the spirit and scope of the invention. For example, the particular structural configuration of a fan made according to the methods of the present invention can vary as desired for particular applications. Moreover, the particular composition of joining (or welding) material utilized can vary as desired for particular applications.

1. A method of making a fan, the method comprising:
making a subassembly comprising a backplate and a plurality of blades extending from the backplate;
making a fan shroud;
positioning the fan shroud adjacent to the blades of the subassembly;
providing ferromagnetic particles at a first weld location; and
directing electromagnetic energy toward the ferromagnetic particles at the first weld location to melt surrounding material and structurally join the fan shroud and at least one of the blades.

2. The method of claim 1, wherein the step of making a subassembly comprises:
overmolding a metallic disk with a polymer material to define the backplate.

3. The method of claim 1, wherein the step of making a subassembly comprises:
integrally molding the backplate and the plurality of blades.

4. The method of claim 1 and further comprising:
positioning a portion of the at least one blade through an opening in the fan shroud.

5. The method of claim 1, wherein providing ferromagnetic particles at the first weld location comprises:
positioning a strand of polymer material containing ferromagnetic particles adjacent to both the fan shroud and at least one of the blades.

6. The method of claim 5, wherein directing electromagnetic energy toward the ferromagnetic particles at the first weld location comprises:
directing electromagnetic energy toward the strand of polymer material containing ferromagnetic particles to melt at least the strand and structurally join the fan shroud and the at least one of the blades.

7. A fan assembly comprising:
a subassembly comprising:
a backplate comprising:
a substantially planar inner diameter portion; and
a substantially frusto-conical outer diameter portion; and
a plurality of blades comprising a polymer material and extending from the backplate, wherein each blade defines an attachment region opposite the backplate, the attachment region comprising:
a weld area; and
a captive area located adjacent to the weld area; and
a fan shroud comprising:
a body having an annular shape and comprising a polymer material;
a plurality of openings through the body, wherein the weld areas of the plurality of blades are positioned at least partially within the corresponding openings through the body; and
a pair of supports integral with the body portion and extending along opposite sides of each of the openings through the body, wherein the captive areas of the plurality of blades are positioned between the corresponding pairs of supports;
wherein weld joints are formed between the weld areas of each of the plurality of blades and the fan shroud, the weld joints containing ferromagnetic particles.

8. The assembly of claim 7, wherein the inner diameter portion of the backplate further comprises:
a metallic disk overmolded with a polymer material.

9. The assembly of claim 7, wherein the subassembly is integrally formed.

10. The assembly of claim 9, wherein the subassembly comprises a polymer material and is integrally molded with an injection molding process.

11. A fan assembly comprising:
a subassembly comprising:
a backplate; and
a plurality of blades extending from the backplate, wherein each blade defines an attachment region opposite the backplate, the attachment region comprising:
a weld area; and
a captive area located adjacent to the weld area;
a fan shroud comprising:
a body having an annular shape; and
a pair of supports extending along opposite sides of each of the openings through the body, wherein the captive areas of the plurality of blades are positioned between corresponding pairs of supports; and
a plurality of openings through the body, wherein the weld areas of the plurality of blades are positioned at least partially within corresponding openings through the body,
wherein weld joints are formed between the weld areas of each of the plurality of blades and the fan shroud, the weld joints containing ferromagnetic particles, and wherein the captive area of at least one of the blades in unwelded.

12. The assembly of claim 11, wherein the body portion of the fan shroud defines a recess at or around each of the openings through the body, each recess located opposite the backplate.

13. The assembly of claim 12, wherein the weld joints are formed within each recess.

14. The assembly of claim 11, wherein the captive area of each blade is located radially inward from the respective weld area.

15. The assembly of claim 11, wherein the backplate defines a substantially planar inner diameter portion and a substantially frusto-conical outer diameter portion.

16. The assembly of claim 11, wherein the subassembly, the fan shroud and the plurality of caps comprise a nylon material.

17. The assembly of claim 11, wherein the subassembly is integrally formed.

18. The assembly of claim 11, wherein the subassembly is integrally molded.
